(19) United States
(12) Patent Application Publication
(10) Pub. No.: US 2019/0109710 A1
(43) Pub. Date: Apr. 11, 2019

(54) SYSTEM AND METHOD FOR RANDOMIZING HIDDEN MESSAGES IN DIGITAL FILES

(71) Applicant: ARP-IP LLC, Santa Barbara, CA (US)

(72) Inventors: Felipe Cariño, JR., Arcadia, CA (US); Anthony Robert Perez, SANTA BARBARA, CA (US); Christopher Randolph Sherman, Playa Del Rey, CA (US)

(21) Appl. No.: 16/154,431

(22) Filed: Oct. 8, 2018

Related U.S. Application Data
(60) Provisional application No. 62/606,741, filed on Oct. 7, 2017.

(51) Int. Cl. H04L 9/08; G06F 21/62; H04N 1/32

(52) U.S. Cl. CPC H04L 9/0866; H04N 2201/3281; H04N 1/32128; G06F 21/6209

(57) ABSTRACT

A system and method for encoding data into a digital file includes identifying an input digital file, an output digital file, and data to be encoded into the output digital file. The data that is to be encoded is masked based on a masking algorithm and encoded into the output digital file at bit locations identified by an encoding algorithm, starting from pre-identified start location. The start location, the masking algorithm, and encoding algorithm are encoded into a metadata file, and the metadata file is also encoded into the output digital file. The input and output digital files are sent to a receiving device that is configured to extract the data from the output digital file, and apply the extracted data to perform an action. The action may be authenticating or authorizing a user based on the extracted data, or completing a transaction.

### CROSS-REFERENCE TO RELATED APPLICATION

This application claims the benefit of U.S. Provisional Application Ser. No. 62/606,741, filed on Oct. 7, 2017, the content of which is incorporated herein by reference.

### BACKGROUND

One of the benefits of the World Wide Web is that it generally allows people to connect globally without substantial barriers. However, this has also led to lack of proper security for users communicating via the web. The lack of proper security exposes users to cyber-criminals, hackers, and others, who want to steal information from people using the web.

As cybercriminals, hackers, terrorists and other bad actors have risen to take advantage of the poor security practices and vulnerabilities of the World Wide Web, the need for protecting, storing, and transmitting information, data, and knowledge securely has grown dramatically. One mechanism for addressing this issue is to use cryptography to store and convert a message from a comprehensible form into an incomprehensible form (encrypting), and back again (decrypting), when the message is ready to be read by an authorized party. Another mechanism is to use steganography to conceal data inside an image, multimedia, and/or any digital file, so that an unauthorized party does not even know that the message exists when looking at the digital image and/or file.

The prior art mechanisms to safeguard data have been generally effective to safeguard private data. However, changes in technology and improvements in Artificial Intelligence (AI) and Machine Learning (ML) threaten to neutralize such effectiveness. Accordingly, what is needed is a system and method for encoding private data into a file that is more secure than traditional mechanisms due to increased entropy or randomness of the encoding.

### SUMMARY

Embodiments of the present invention are directed to a system and method for encoding data into a digital file. The method is implemented via a processor and a memory, where the memory includes instructions that, when implemented by the computer, cause the computer to take actions to perform the encoding. According to one embodiment, the processor identifies a first digital file, a second digital file, and data to be encoded. The processor also identifies a start location in the second digital file for encoding the data, as well as a first function or algorithm, and a second function or algorithm. The processor inputs a first bit of the first file and a first bit of the data, into the first function or algorithm, and generates an output first bit in response. The output first bit is encoded at the start location in the second file. The processor also inputs a second bit of the first file and a second bit of the data, into the first function or algorithm, and generates an output second bit in response. A second location in the second file is identified based on the second function or algorithm, and the output second bit is encoded to the identified second location. The start location, the first function or algorithm, and the second function or algorithm are encoded into a metadata file, and the metadata file is encoded into the second digital file. The processor sends the first and second digital files to a receiving device that is configured to extract the data from the second digital file, and apply the extracted data to perform an action. The action may be authenticating or authorizing a user based on the extracted data, or completing a transaction.

According to one embodiment of the invention, the first digital file is an image or multimedia file.

According to one embodiment of the invention, the second digital file is a copy of the first digital file with the encoded data, wherein differences between the first digital file and the second digital file are visually imperceptible.

According to one embodiment of the invention, the second digital file is a file other than a copy of the first digital file.

According to one embodiment of the invention, the start location is a first particular bit position in the second digital file, and the second location is a second particular bit position in the second digital file. The first bit position can be numerically the same or different from the second bit position.

According to one embodiment of the invention, the data comprises at least one of alphanumeric characters or digital content.

According to one embodiment of the invention, the processor receives from a user device, identification of the data to be encoded into the second digital file.

According to one embodiment of the invention, the first function or algorithm is a Boolean operation.

According to one embodiment of the invention, the second function or algorithm is a mathematical function.

According to one embodiment of the invention, the metadata file further identifies a length of the data.

According to one embodiment of the invention, the data encoded into the second file utilizes a particular coded character set selected from a plurality of coded character sets, and the metadata file further identifies the particular coded character set.

According to one embodiment of the invention, the processor displays a plurality of second functions or algorithms and receives user selection of the second function or algorithm from the displayed plurality of second functions or algorithms.

According to one embodiment of the invention, the processor encrypts the metadata file based on an encryption algorithm, wherein the metadata encoded into the second digital file is the encrypted metadata file.

According to one embodiment of the invention, at least the start location, first function or algorithm, or second function or algorithm, is randomly selected by the processor or user.

According to one embodiment of the invention, the encoding of the data includes invoking a wrap-around function in response to the second location exceeding a boundary of the second digital file.

### BRIEF DESCRIPTION OF THE DRAWINGS

FIG. 1 is a schematic block diagram of a system for encoding data into a digital file according to one embodiment of the invention;

FIG. 2 is a flow diagram of a process for encoding data into a digital file according to one embodiment of the invention;

FIG. 3 is a more detailed flow diagram of the process of FIG. 2, for encoding data into a digital file according to one embodiment of the invention;

FIG. 4 is a flow diagram of a process for extracting and decoding encoded data according to one embodiment of the invention;

FIG. 5 is a schematic layout diagram of an exemplary message that may be encoded into an output file according to one embodiment of the invention;

FIG. 6 is a schematic layout diagram of binary bit values of “H” in ASCII, and corresponding byte and byte bit locations of an output file where the binary representation is hidden in an output file;

FIG. 7A is a photograph of an initial image file;

FIG. 7B is a photograph of a copy of the initial image file of FIG. 6A, with the message “Hidden Message!” encoded into it; and

These and other features, aspects and advantages of the present invention will be more fully understood when considered with respect to the following detailed description, appended claims, and accompanying drawings. Of course, the actual scope of the invention is defined by the appended claims.

### DETAILED DESCRIPTION

Embodiments of the present invention are directed to a system and method that conceals data into a digital file. The data to be concealed is any type of data that may be transmitted electronically using electronic devices such as computers, smart phones, tablets, Internet of Things (IOT) devices and applications, Internet and Intranet networks, or the like. Such data may include, but is not limited to, security codes, private messages, user identification information, computer code, intellectual property, legal or financial information, proprietary or public data with or without limited audience controls and permissions, and/or digital files (e.g. multimedia files, digital image files, word processing files, spreadsheet files, database files, or the like).

According to one embodiment, a processor configured to encode the data into the digital file identifies a start location (e.g. a particular start bit location) of the file where the encoding is to begin. The data is encoded bit-by-bit into the digital file until the data is completely embedded. According to one embodiment if the start location of the first bit is near the end boundary of the digital file and the encoding is not able to embed all of the data before reaching the end boundary, the algorithm provides a wrap-around feature that allows the data to be completely embedded in the digital file. The particular bits of the digital file, following the start bit location, where the data is to be stored, is determined by a function or algorithm which may generally be referred to as an encoding algorithm. Embodiments of the present invention provide randomness or entropy to the encoding process because the start location and encoding algorithm may differ from time to time, from user to user, from data to data, and/or the like. For example, the impact of using one random bit as the start location dramatically increases entropy (randomness) of the general encoding process according to the various embodiments of the invention, making the process less susceptible to hacking.

According to one embodiment, a masking function is used for masking the data that is encoded, and adding more randomness to the encoding process. The masking function may also differ from time to time, from user to user, or from data to data. According to one embodiment, the masking function is used for conducting bitwise operations of the binary representation of the data, with bits making up an initial input file, and storing the output bits of the operation (also referred to as the masked bits) as the encoded bits.

According to one embodiment, the encoding parameters are stored into a metadata file, and the metadata file is also encoded into the digital file. The initial input file and the digital file containing the encoded data and metadata are then provided to an entity that has the functionality to decode and extract the hidden data.

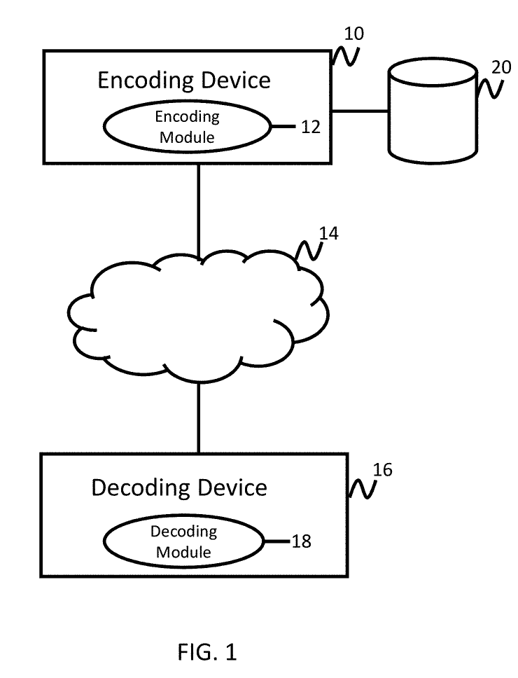

FIG. 1 is a schematic block diagram of a system for encoding data into a digital file according to one embodiment of the invention. The system includes an encoding device 10 and a decoding device 16 coupled to each other over a data communications network 12. According to one embodiment, the data communications network 12 is a public wide area network such as the Internet.

The encoding and decoding devices 10, 16 may each be a computing device conventional in the art such as, for example, a server, computer, smart phone, smart watch, laptop, electronic tablet, IOT device, and/or the like. Each device 10, 16 includes one or more processors, memory, input devices (e.g. mouse and keyboard), output devices (e.g. one or more display screens), and a wired or wireless network interfaces.

According to one embodiment, the encoding device 10 includes an addressable memory for storing software instructions to be executed by a processor. The memory is implemented using a standard memory device, such as random access memory (RAM). In one embodiment, the memory stores an encoding module 12 configured with computer program instructions for encoding, into an output file, any type of data (also referred to as secret/private data or hidden message) that is intended to be kept secret from unauthorized entities. Once encoded, the output file may be stored in a mass storage device 20 for later use. The mass storage device 20 may be implemented as a hard disk drive, cloud and/or server farm, or other suitable mass storage device.

According to one embodiment, the encoding device 10 includes a web browsing software for communicating with the decoding device 16 over the web. The communication may be, for example, to provide the output file with the hidden message to the decoding device 16. For example, the output file may be provided to the decoding device 16 as part of a login process for authenticating and/or authorizing a user to access resources of the decoding device 16. In another example, the output file may be provided to the decoding device for finalizing a transaction.

According to one embodiment, the decoding device 16 may be a web server or another device that hosts a decoding module 18. In this regard, the decoding device also includes an addressable memory for storing software instructions to be executed by a processor. The memory is implemented using a standard memory device, such as random access memory (RAM). In one embodiment, the memory stores the decoding module 18 configured with computer program instructions for extracting and decoding hidden messages in received output files. Once extracted, the messages may then be provided to other applications hosted by the decoding device 16 for taking an action. Such actions may include, without limitation, authenticating and/or authorizing the user to access resources of the decoding device 16, applying contents of the message to finalize a transaction, and/or the like.

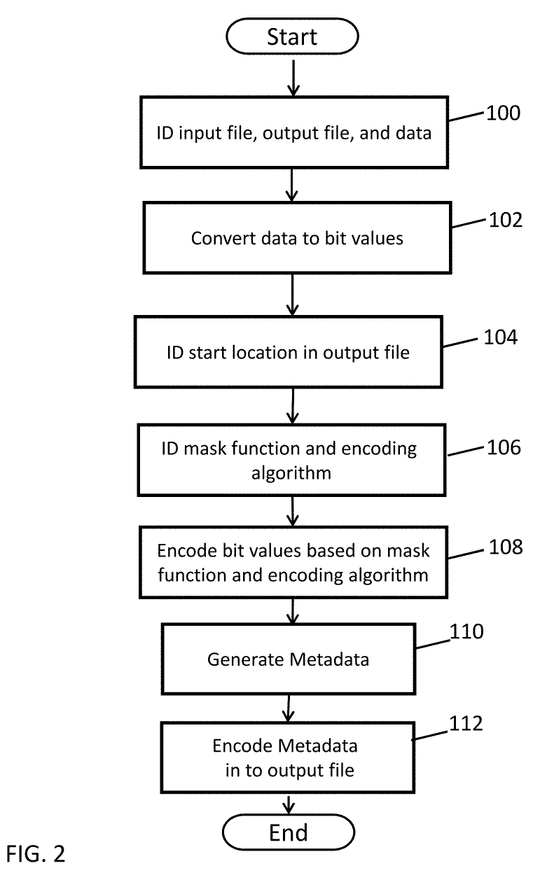

FIG. 2 is a flow diagram of a process for encoding data into a digital file according to one embodiment of the invention. The process may be initiated by a user accessing the encoding device 10. The user may be, for example, an end user encoding messages for his or her personal use, or an administrator of a business who encodes hidden messages for various employees of the business. For simplicity purposes, it is assumed that the user described in conjunction with FIG. 2 is an end user encoding messages for his or her personal use.

The process of FIG. 2 may be described in terms of a software routine executed by the processor of the encoding device 10 based on instructions stored in memory. A person of skill in the art should recognize, however, that the routine may be executed via hardware, firmware (e.g. via an ASIC), or in any combination of software, firmware, and/or hardware. Furthermore, the sequence of steps of the process is not fixed, but can be altered into any desired sequence as recognized by a person of skill in the art.

The process starts, and in act 100, the encoding module 12 identifies an input/original file, output file, and secret data that is to be hidden in the output file for the user. According to one embodiment, the encoding module 12 provides a graphical user interface accessible to the user for selecting, entering, and/or uploading the files and secret data. In one example described herein, the secret data is an alphanumeric message typed-in by the user via the graphical user interface. However, the secret data may be any digital data conventional in the art, including image files, multimedia files, text files, computer code, and/or any digital data or file provided by the user.

According to one embodiment, the user might be prompted by the graphical user interface to manually select a particular input file and/or output file. In other embodiments, the input and/or output files are automatically selected and/or generated by the encoding module 12. The input and output files may be of the same type of different type. According to one embodiment, the output file is a copy of the input file. For example, the input file may be an image file, and the output file is a copy of the same image file.

In act 102, the encoding module converts the data to be encoded, into a binary representation of the data. The binary representation may depend on the particular coded character set that is used for the encoding. Exemplary coded character sets that may be used include, without limitation, ASCII, Unicode, EBCDIC, and/or the like.

In act 104, the encoding module 12 identifies a start location of the output file where the encoding of the message is to start. According to one embodiment, the start location is a particular bit position in the output file.

In act 106, the encoding module identifies a masking algorithm for masking the secret data, and an encoding algorithm for identifying specific bit locations of the output file and storing the masked data at the identified bit locations. Although reference is made to an algorithm, generally, an algorithm may also be a function, formula, or the like.

According to one embodiment, the masking algorithm identifies a Boolean operation to be applied to the binary representation of the message, and the bits in the initial file. In this regard, the masking algorithm identifies a start bit position of the input file where the Boolean operation is to begin to mask the bit values making up the message. Such start bit position of the input file may be preset as a configuration parameter for the masking algorithm. The Boolean operation may be, for example, an AND operation, OR operation, XOR operation, and/or the like. The masking algorithm may also identify other bitwise operations to be performed to the bits of the message, such as inverting the bits or performing some other complex or non-complex bit manipulations. For simplicity purposes, the masking operation that is assumed to be used for the embodiments described herein is a Boolean operation.

According to one embodiment, the encoding algorithm that is identified by the encoding module may be any algorithm that outputs bit positions of the output file in which the masked data is to be stored. For example, the encoding algorithm may output a modified Fibonacci sequence (e.g. 1, 2, 3, 5, 8, 13, 21, 34, 55, 89, 144 . . . ) as the sequence of bit locations to be used for embedding the masked bits following the start bit location. According to one embodiment, the start of the sequence of bits may be the same as the start bit location. According to another embodiment, the start of the sequence of bits is different from the start bit location.

In another example, the output sequence of bit locations may form Pascal's triangle, where the center value of the triangle is used as the bit location. A custom-built algorithm may also be used for generating the sequence of bit locations.

According to one embodiment, the encoding algorithm employs a wrap-around function if a particular bit location for storing a bit of the message exceeds a boundary of the output file. The wrap-around function may employ modular arithmetic for computing a bit location outside of the boundary, as a modulus of the size of the output file.

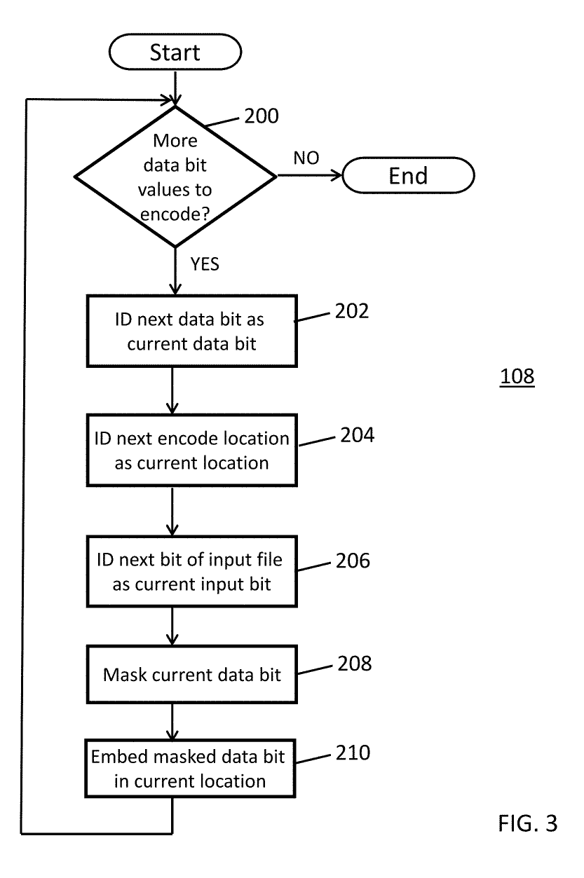

In act 108, the encoding algorithm invokes the identified mask function and encoding algorithm to encode the secret data into the output file as described in more detail with respect to FIG. 3.

In act 110, the type of coded character set that is used for the encoding, length of the message (e.g. total number of bits), bit location in the output file where the message starts, the identified encoding algorithm, and the identified masking algorithm, are all stored into a metadata file.

In act 112, the metadata file is encoded into the output file starting at a particular start location as determined by the encoding algorithm. The particular start location may be preset as a configuration parameter of the encoding algorithm. According to one embodiment, the metadata file may be encrypted according to any encryption algorithm, and the encrypted metadata file may then be embedded into the output file. According to one embodiment, a binary representation of the metadata file may also be masked according to the same or different masking algorithm as the masking algorithm employed to mask the hidden message.

According to one embodiment, the start location of the output file where data is to start being embedded, the coded character set to be employed, the start location of the metadata object, and the masking and encoding algorithms that are used, are specified by the user via the graphical user interface, or automatically selected by the encoding module (e.g. on a random basis or based on a selection algorithm). The manual and/or automatic selection may occur once during configuration of the encoding module, or each time a particular trigger condition is detected. The trigger condition may be, for example, passage of a certain time period, a request from the user to encode a message, and/or the like. In this regard, the change of the start location of the output file and/or the change of the masking and encoding algorithms from message to message adds entropy and randomness to the encoding process that helps guard the message from being accessed by unauthorized users.

FIG. 3 is a more detailed flow diagram of the process of act 108 for encoding the secret data into the output file according to one embodiment of the invention.

In act 200, the encoding module determines whether there are any more bit values of the secret data to be encoded. If there are no more bit values to encode, the process ends.

Otherwise, in act 202, the encoding module identifies a next bit of the data to be encoded, as the current data bit.

In act 204, the encoding module identifies a next bit location of the output file, as a current location. The next bit location of the output file is determined by the selected encoding algorithm.

In act 206, the encoding module identifies a next bit of the input file, as a current input bit.

In act 208, the encoding module invokes the selected masking algorithm to mask the current data bit based on the current input bit, and generates a masked data bit in response. Of course, as a person of skill in the art should appreciate, if the masking algorithm is one that performs manipulations of the bits of the message without the need of an input file, the steps described herein involving the input file may be skipped.

In act 210, the encoding module embeds the masked data bit into the identified current location of the output file.

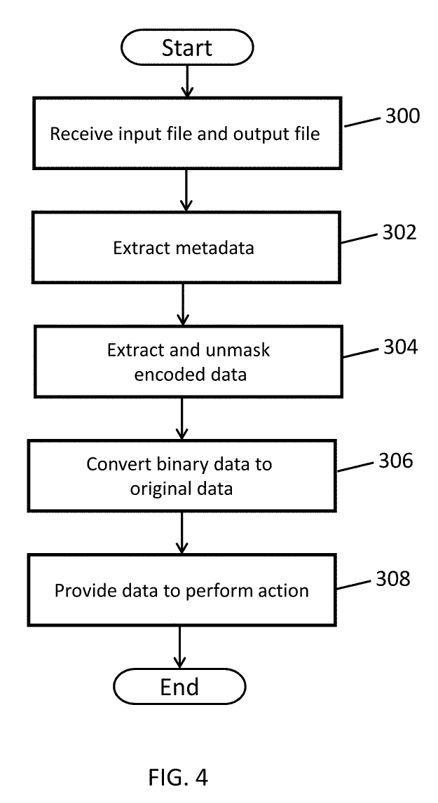

FIG. 4 is a flow diagram of a process for extracting and decoding the secret data according to one embodiment of the invention. The process may be described in terms of a software routine executed by the processor of the encoding device 10 based on instructions stored in memory. A person of skill in the art should recognize, however, that the routine may be executed via hardware, firmware (e.g. via an ASIC), or in any combination of software, firmware, and/or hardware. Furthermore, the sequence of steps of the process is not fixed, but can be altered into any desired sequence as recognized by a person of skill in the art.

In act 300, the decoding device 16 receives the input file and the output file from the encoding device 10. The files may be transmitted, for example, over the data communications network 14 as part of a request transmitted by the encoding device, or in response to a prompt from the decoding device.

In act 302, the decoding module 18 extracts the metadata from the output file. In this regard, the start position of the output file from where the metadata may be retrieved may be preset as a configuration parameter of the decoding module 18. Once retrieved, the metadata object provides the decoding module 18 the start location of the encoded message, as well as the encoding algorithm that identifies the bit locations of the output file that contain the embedded message. The total number of bits of the hidden message, the character encoding that was used for the encoding, and the masking function that was used to hide the message, are also identified from the metadata file.

In act 304, the information retrieved from the metadata file is used to extract and unmask the encoded data. In this regard, the decoding module 18 engages in bit-by-bit extraction of the encoded message from the bit locations identified by the start location, and the bit locations generated by invoking the encoding algorithm. The extracted data is then unmasked, bit-by-bit by performing a reverse operation of the mask function that was used to do the masking.

In act 306, the binary representation of the unmasked data is converted back into the original form, whether it be a text, a file, or other type of digital data.

In act 308, the extracted message is provided to a requesting process for taking an action based on the extracted message. According to one embodiment, the unmasked data is destroyed after use. In another embodiment, the unmasked data is saved into a data storage device.

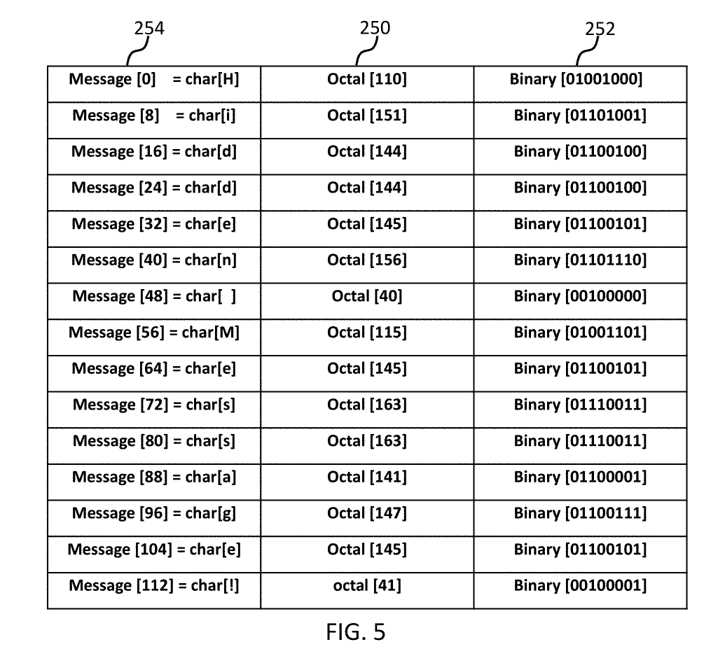

FIG. 5 is a schematic layout diagram of an exemplary message that may be encoded into the output file according to one embodiment of the invention. The exemplary message is the phrase “Hidden Message!.” The octal 250 and binary 252 representations of each character 254 of the message are then embedded into the output file.

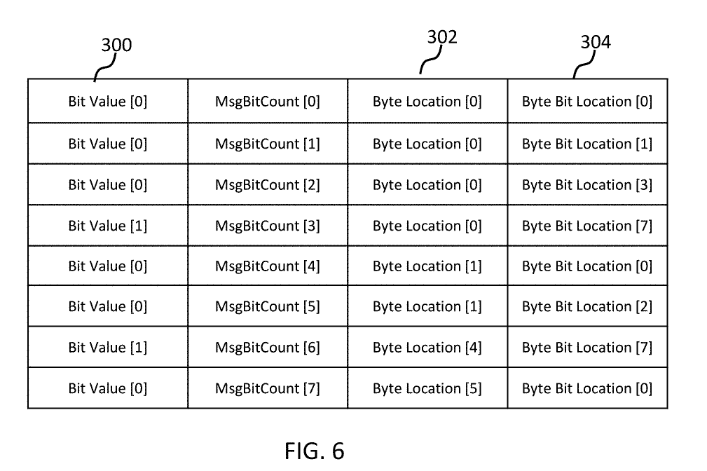

FIG. 6 is a schematic layout diagram of binary bit values 300 of the first character “H” of “Hidden Message!” in ASCII (i.e. 01001000, starting from bit 7), and corresponding byte 302 and byte bit locations 304 of the output file, for encoding the bit values. The byte and byte bit locations are derived from the position number that is output by the encoding algorithm.

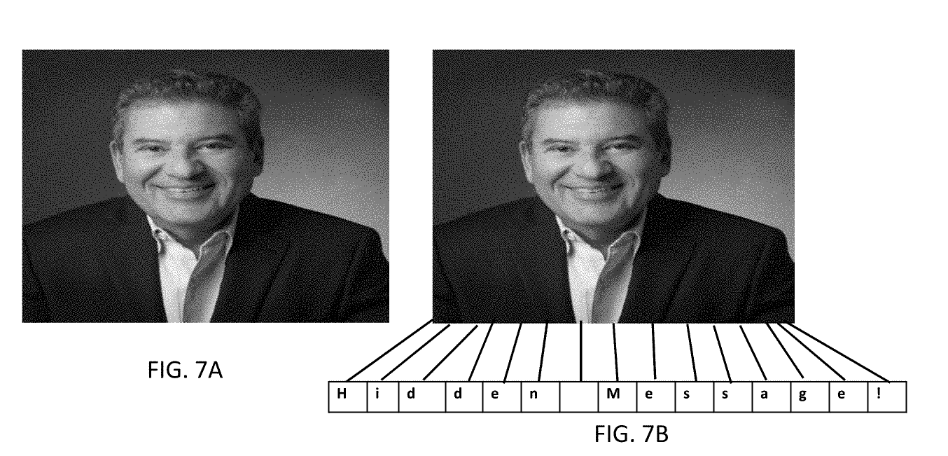

As discussed, the output file used for encoding the private message may be a copy of the original input file. FIG. 7A is a photograph of an initial image file, and FIG. 7B is a photograph of a copy of the initial image file with the message “Hidden Message!” encoded into it, in the byte and byte-bit locations identified in FIG. 6. The changes made to the image in FIG. 7B due to the encoding of the message are visually imperceptive to the naked eye.

It is the Applicant's intention to cover by claims all such uses of the invention and those changes and modifications which could be made to the embodiments of the invention herein chosen for the purpose of disclosure without departing from the spirit and scope of the invention. Thus, the present embodiments of the invention should be considered in all respects as illustrative and not restrictive.

1. A method for encoding data into a digital file, the method comprising:
identifying, by a processor, a first digital file, a second digital file, and data to be encoded;
identifying, by the processor, a start location in the second digital file for encoding the data;
identifying, by the processor, a first function or algorithm, and a second function or algorithm;
inputting, by the processor, a first bit of the first file and a first bit of the data, into the first function or algorithm, and generating an output first bit in response;
encoding, by the processor, the output first bit at the start location in the second file;
inputting, by the processor, a second bit of the first file and a second bit of the data, into the first function or algorithm, and generating an output second bit in response;
identifying, by the processor, a second location in the second file based on the second function or algorithm;
encoding, by the processor, the output second bit to the identified second location in the second file;
saving, by the processor, into a metadata file, the start location, the first function or algorithm, and the second function or algorithm;
encoding the metadata file into the second digital file;
transmitting the first and second digital files to a receiving device, wherein the receiving device is configured to extract the data from the second digital file and apply the extracted data to perform an action.

2. The method of claim 1, wherein the first digital file is an image or multimedia file.

3. The method of claim 1, wherein the second digital file is a copy of the first digital file with the encoded data, wherein differences between the first digital file and the second digital file are visually imperceptible.

4. The method of claim 1, wherein the second digital file is a file other than a copy of the first digital file.

5. The method of claim 1, wherein the start location is a first particular bit position in the second digital file, and the second location is a second particular bit position in the second digital file.

6. The method of claim 1, wherein the first bit position is the same from the second bit position.

7. The method of claim 1, wherein the first bit position is different from the second bit position.

8. The method of claim 1, wherein the data comprises at least one of alphanumeric characters or digital content.

9. The method of claim 1 further comprising:
receiving from a user device, identification of the data to be encoded into the second digital file.

10. The method of claim 1, wherein the first function or algorithm is a Boolean operation.

11. The method of claim 1, wherein the second function or algorithm is a mathematical function.

12. The method of claim 1, wherein the metadata file further identifies a length of the data.

13. The method of claim 1, wherein the data encoded into the second file utilizes a particular coded character set selected from a plurality of coded character sets, and the metadata file further identifies the particular coded character set.

14. The method of claim 1 further comprising:
displaying a plurality of second functions or algorithms; and
receiving user selection of the second function or algorithm from the displayed plurality of second functions or algorithms.

15. The method of claim 1 further comprising:
encrypting the metadata file based on an encryption algorithm, wherein the metadata encoded into the second digital file is the encrypted metadata file.

16. The method of claim 1, wherein the action is authenticating or authorizing a user based on the extracted data.

17. The method of claim 1, wherein the action is completing a transaction.

18. The method of claim 1, wherein at least the start location, first function or algorithm, or second function or algorithm, is randomly selected by the processor or user.

19. The method of claim 1, wherein encoding of the data includes invoking a wrap-around function in response to the second location exceeding a boundary of the second digital file.

20. A system for encoding data into a digital file, the system comprising:
a processor; and
a memory coupled to the processor, the memory storing instructions that, when executed by the processor, cause the processor to:
identify a first digital file, a second digital file, and data to be encoded;
identify a start location in the second digital file for encoding the data;
identify a first function or algorithm, and a second function or algorithm;
input a first bit of the first file and a first bit of the data, into the first function or algorithm, and generating an output first bit in response;
encode the output first bit at the start location in the second file;
input a second bit of the first file and a second bit of the data, into the first function or algorithm, and generating an output second bit in response;
identify a second location in the second file based on the second function or algorithm;
encode the output second bit to the identified second location in the second file;
save into a metadata file, the start location, the first function or algorithm, and the second function or algorithm;
encode the metadata file into the second digital file;
transmit the first and second digital files to a receiving device, wherein the receiving device is configured to extract the data from the second digital file and apply the extracted data to perform an action.

21. The system of claim 20, wherein the second digital file is a file other than a copy of the first digital file.

22. The system of claim 20, wherein at least the start location, first function or algorithm, or second function or algorithm, is randomly selected by the processor or user.
